(19) United States
(12) Patent Application Publication
(10) Pub. No.: US 2005/0279083 A1
(43) Pub. Date: Dec. 22, 2005

(54) Folded detonation initiator for constant volume combustion device

(75) Inventors: Keith Robert McManus, Clifton Park, NY (US); Anthony John Dean, Scotia, NY (US); Venkat Eswarlu Tangirala, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 10/870,877

(22) Filed: Jun. 18, 2004

(51) Int. Cl. F02K 7/02

(52) U.S. Cl. 60/247

(57) ABSTRACT

In the present invention, at least one detonation initiator is positioned downstream of a main combustion chamber, with the initiator oriented such that it projects a detonation initiation wave forward into the main combustion chamber. The main combustion chamber contains a wave reflection surface. The detonation initiation wave is directed into the main combustion chamber and at the wave reflector surface and is used to initiate, or assist in the initiation of, a fuel and gas mixture in the main combustion chamber. The fuel and gas mixture is detonated, creating a high temperature and high pressure wave that is directed out of the main combustion chamber.

This invention was made with government support under Contract No. DABT63-00-C-0001 awarded by DARPA. The government may have certain rights to the invention.

### BACKGROUND OF THE INVENTION

This invention relates to pulse detonation engines, and more particularly, to a specific type of detonation initiator for pulse detonation combustors.

In recent years, efforts to address the need of a combination of combustion systems to obtain a wide range of flight speeds for aircraft have led to the development of pulse detonation combustors, which can be used for propulsion applications including aircraft engines (as well as several other applications). When used on aircraft engines, pulse detonation engines aid in increasing the available flight speed range of an aircraft engine while reducing the fuel consumption.

Pulse detonation combustors operate using detonation waves, created by combusting a mixture of gas (typically air) and a fuel in a confined volume. The detonation waves exit the pulse detonation combustor tube as pulses, thus providing thrust. Because of the nature of the operation of pulse detonation combustors, i.e. using shock focusing to create a detonation within the combustion chamber, there is a need to aid, or increase the efficiency of, the detonation. There is an additional need that the detonations are sufficiently controlled such that there are no “missed” detonations.

In an effort to address these concerns there have been a number of configurations employed. One such configuration employs oxygen-enriched detonation initiators positioned upstream of the combustion chamber. The oxygen-enriched initiator would detonate and fire into the main combustion chamber to assist the detonation of the combustible components in the main combustion chamber. However, there remains a need for improvement.

### SUMMARY OF THE INVENTION

In an embodiment of the invention, an initiator is positioned downstream of main combustion chamber of a constant volume combustion device (for example a pulse detonation combustor) or detonation chamber, whereas the initiator is oriented such that it directs a strong compression wave forward into the main combustion chamber. Specifically, this detonation initiation wave is directed at a wave reflector surface and the reflected compression wave promotes, or assists in the initiation, of a fuel and gas mixture in the main combustion chamber.

During the operation of the combustion device, a fuel and gas mixture is injected into the main combustion chamber of the combustion device. When the combustion chamber is filled with fuel-gas mixture, the initiator fires a detonation initiation wave through the main combustion chamber at a wave reflection surface. Either during the initial pass of the detonation initiation wave through the main combustion chamber, or after the detonation initiation wave is reflected off of the wave reflection surface, the detonation initiation wave assists in, or triggers, detonating the fuel and gas mixture in the main combustion chamber. After initiation, the detonation wave travels out of the main combustion chamber and out through a downstream exit of the combustion device.

### BRIEF DESCRIPTION OF THE DRAWINGS

The advantages, nature and various additional features of the invention will appear more fully upon consideration of the illustrative embodiment of the invention which is schematically set forth in the figures, in which:

FIG. 1 is a diagrammatical representation of an embodiment of the present invention having a single initiator positioned centrally;

FIG. 2 is a diagrammatical representation of an additional embodiment of the present invention having a plurality of initiators positioned centrally;

FIG. 3 is a diagrammatical representation of another embodiment of the present invention having a plurality of initiators positioned radially;

FIG. 4 is a diagrammatical representation of a further embodiment of the present invention having a plurality of initiators positioned externally;

FIG. 5 is a cross-sectional view of the embodiment depicted in FIG. 1;

FIG. 6 is a cross-sectional view of the embodiment depicted in FIG. 2;

FIG. 7 is a cross-sectional view of the embodiment depicted in FIG. 3; and

FIG. 8 is a diagrammatical representation of a further embodiment of the present invention.

### DETAILED DESCRIPTION OF THE PREFERRED EMBODIMENT

The present invention will be explained in further detail by making reference to the accompanying drawings, which do not limit the scope of the invention in any way.

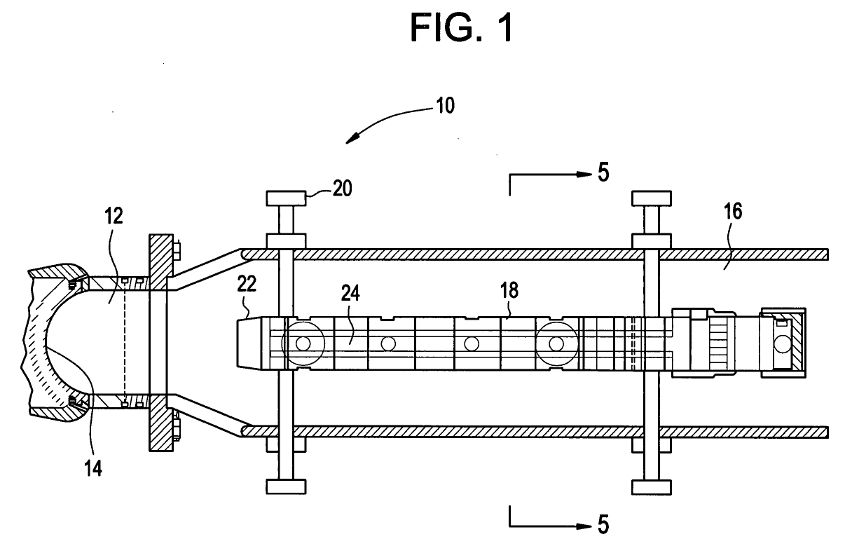

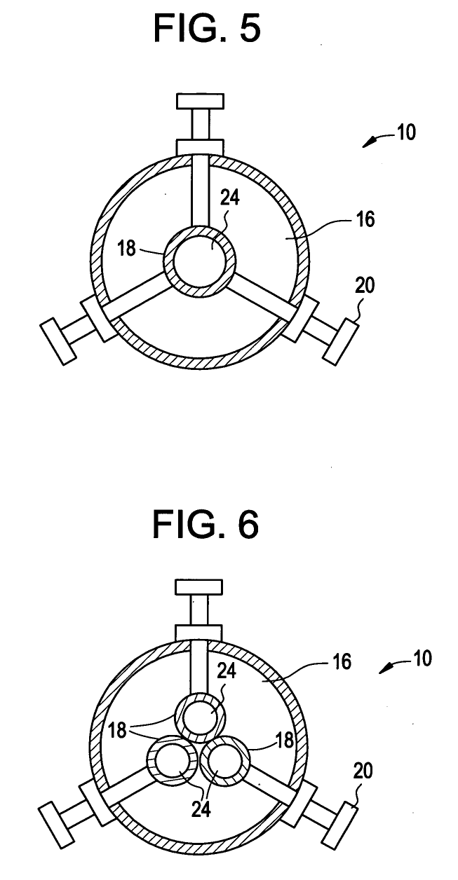

FIGS. 1 through 4 show alternative embodiments of a constant volume combustion device 10 having a main combustion chamber 12, a wave reflection surface 14, an exhaust tube 16, and at least one detonation initiator 18. The detonation initiator(s) 18 are held within the exhaust tube 16 with support structure 20. FIGS. 5 through 7 show cross-sectional views of the embodiment of the present invention depicted in FIGS. 1 through 3, respectively.

Turning now to FIG. 1, a constant volume combustion device 10 is shown (for example a pulse detonation combustor) having a single detonation initiator 18 positioned within the exhaust tube 16 of the device 10. The detonation initiator 18 is positioned centrally within the exhaust tube 16 and is directed upstream at the main combustion chamber 12 and wave reflection surface 14 of the device 10. The detonation initiator 18 is secured into position using support structure 20. This is depicted in FIG. 5, which is a cross-section of the device 10 taken along the section I-I. In an embodiment of the invention, the detonation initiator 18 is itself a constant volume combustion device, for example a deflagration to detonation tube, which creates a detonation initiation wave that is directed upstream at the wave reflection surface 14.

The detonation initiator 18 has a nozzle 22, through which the detonation initiation wave exits the detonation initiator 18. In an embodiment, the nozzle 22 is a converging-diverging nozzle. In another embodiment, the nozzle 22 is a converging nozzle having an exit diameter, which is smaller than the internal cross-sectional diameter of the initiator exhaust tube 24. In a further embodiment the exit diameter of the nozzle 22 is 80% of the diameter of the initiator exhaust tube 24.

The operation of the combustion device 10, shown in FIG. 1 will now be discussed. A fuel and gas mixture is injected into the main combustion chamber 12 under pressure. In one embodiment the gas is air. The fuel mixture is injected into the main combustion chamber 12 under a constant pressure. In one embodiment, the fuel mixture flow is controlled by a valve mechanism, which closes at the proper fill level, whereas in an alternative embodiment there is no valve mechanism and the flow into the main combustion chamber 12 is choked as a result of the detonation pressure wave in the main chamber 12. At approximately the same time as the main chamber 12 is filling, the combustion chamber of the detonation initiator 18 is also being filled. In one embodiment, the fuel mixture for the main combustion chamber 12 is the same fuel mixture used in the detonation initiator 18. In another embodiment, the gas for the fuel and gas mixture used in the detonation initiator 18 is oxygen, or another gas besides air.

When the fuel mixture in the main combustion chamber reaches a certain level the fuel mixture in the detonation initiator 18 is detonated. This detonation occurs through use of any known detonation method, including (but not limited to) spark, laser, energy deposition, and spontaneous detonation. After detonation, a detonation initiation wave travels through the initiator exhaust tube 24 of the detonation initiator 18, and exits out of the nozzle 22.

Using the orientation of the nozzle and/or the detonation initiator 18, the detonation initiation wave is directed into the main combustion chamber 12. The high temperature and pressure of the detonation initiation wave triggers the detonation of the fuel mixture within the main combustion chamber 12, which creates an additional high temperature and high pressure wave. The newly created detonation wave then exits the combustion device 10 through an exhaust tube 16, thus creating thrust. Because of the nature of the detonation a portion of the newly created detonation is immediately directed out of the exhaust tube 16, while a portion is reflected off of the wave reflection surface 14, and then along the exhaust tube 16.

In an alternative embodiment, the detonation wave from the detonation initiator 18 is timed such that it does not detonate the fuel mixture in the main combustion chamber 12 on its first pass through the chamber 12, but the detonation wave is first reflected off of the wave reflection surface 14 and back into the main combustion chamber 12, at which time the fuel mixture is detonated.

In an additional embodiment, a first detonation initiation of the fuel mixture occurs as the detonation initiation wave first passes through the main combustion chamber, and a second detonation, of any remaining non-detonated fuel mixture, is initiated, thus increasing the overall combustion efficiency of the device 10. In a further alternative embodiment, the detonation of the fuel mixture within the main combustion chamber 12 is assisted by means other than the detonation initiation wave. For example, in addition to the detonation initiation wave, it is contemplated that a sparking or laser mechanism being coupled to the main combustion chamber 12 to assist in the detonation of the fuel mixture.

To provide sufficient performance of the device 10, the wave reflection surface 14 is configured and shaped to provide sufficient shock wave focusing in the main combustion chamber 12. In one embodiment, the wave reflection surface is parabolic, while in other embodiments the shape is semi-spherical, conical, flat, or the like.

Because of the nature of the detonation in the device 10, the support structure 20, wave reflection surface 14, main combustion chamber 12, exhaust tube and detonation initiator 18 are made from materials which can withstand a high temperature and high pressure environment. Additionally, the support structure is formed aerodynamically to reduce its interference with the flow of the pressure wave along the exhaust tube 16.

In an embodiment of the present invention, the fuel mixture for the detonation initiator 18 is routed through the support structure 20. In an additional embodiment a cooling medium is passed through a manifold structure within the support structure 20 to cool the detonation initiator 18.

The nozzle 22 is configured so as to direct the detonation initiation wave at the reflection surface, and at the same time limit the amount of the main detonation which enters the detonation initiator 18 as the main detonation wave exits the main combustion chamber 12 and passes through the exhaust tube 16. In one embodiment the nozzle shape is circular. However, in additional embodiment the shape of the nozzle is optimized to provide for directed flow out of the detonation initiator 18 while preventing back-flow from the main combustion chamber 12. Examples of the nozzle 22 shape include rectangular, square, oval, octagonal, or the like.

Further, the positioning of the detonation initiator 18 and the nozzle from the wave reflection surface 14 and main combustion chamber 12 is determined to optimize the overall operation of the combustion device. In one embodiment, the detonation initiator 18 is configured and positioned to permit a portion of the main detonation wave from the combustion chamber 12 to enter the detonation initiator 18 and assist in the detonation initiation within the detonation initiator 18. In a further embodiment, the detonation initiator 18 is positioned and configured so that the detonation initiation wave from the detonation initiator 18 approaches the nozzle 22 opening at about the time the main detonation wave from the previous main chamber 12 detonation passes the detonation initiator 18. Thus, the detonation initiation wave assists in preventing back-flow into the detonation initiator 18 from the main combustion chamber 12. In yet a further embodiment, a valve structure (not shown) is coupled with the nozzle 22 to prevent back-flow into the detonation initiator 18 from the detonation of the fuel mixture in the main combustion chamber 12.

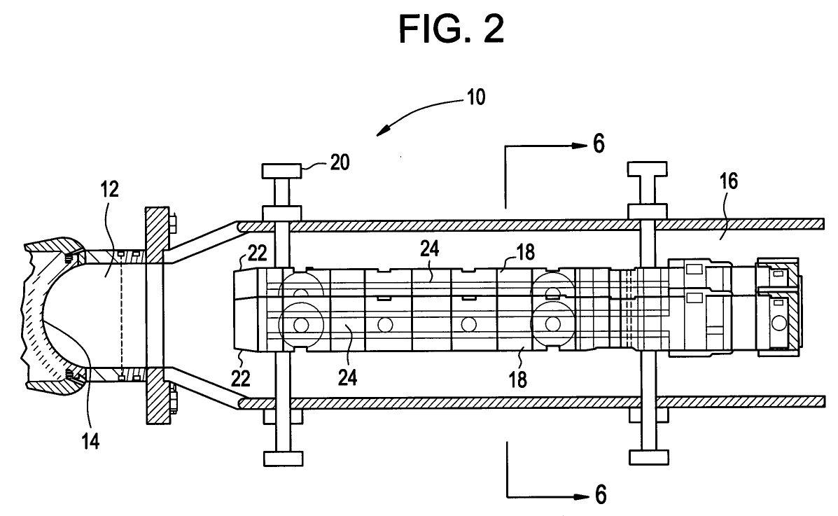

FIG. 2 depicts an alternative embodiment of the present invention, where a plurality of detonation initiators 18 are positioned centrally within the combustion device 10. This is depicted in FIG. 6, which is a cross-section of the device 10 taken along the section II-II. In this embodiment, the overall operation of the device 10 and the detonation initiators 18 is similar to that described above. However, in one embodiment, all of the detonation initiators 18 fire simultaneously, whereas in an alternative embodiment the detonation initiators 18 fire in sequence. Firing the detonation initiators 18 in sequence aids in cooling of the detonation initiators 18 because each of the detonation initiators 18 have a series of cycles where they are not detonating an initiation wave, thus allowing them to internally cool between detonations. In this embodiment, the overall operational frequency of the device 10 can be increased.

In a further embodiment, the detonation initiators 18 are fired out of phase with each other and, during operation, the fuel mixture for the main combustion chamber 12 is supplied from the detonation initiator(s) 18 which are not firing at that time. For example, in an embodiment with three detonation initiators 18, only one initiates a detonation initiation wave at a time, while the remaining two supply the fuel air mixture for the main combustion chamber. This embodiment also assists in cooling as the flow of the fuel mixture through the two non-detonating detonation initiators 18 will assist in cooling the internal portions of the detonation initiators 18.

Although the embodiment in FIG. 2 is shown with three detonation initiators 18, alternative embodiment are contemplated having as few as two detonation initiators 18, and more than three detonation initiators 18. The number of detonation initiators 18 are chosen to optimize the operational performance and characteristics of the combustion device 10.

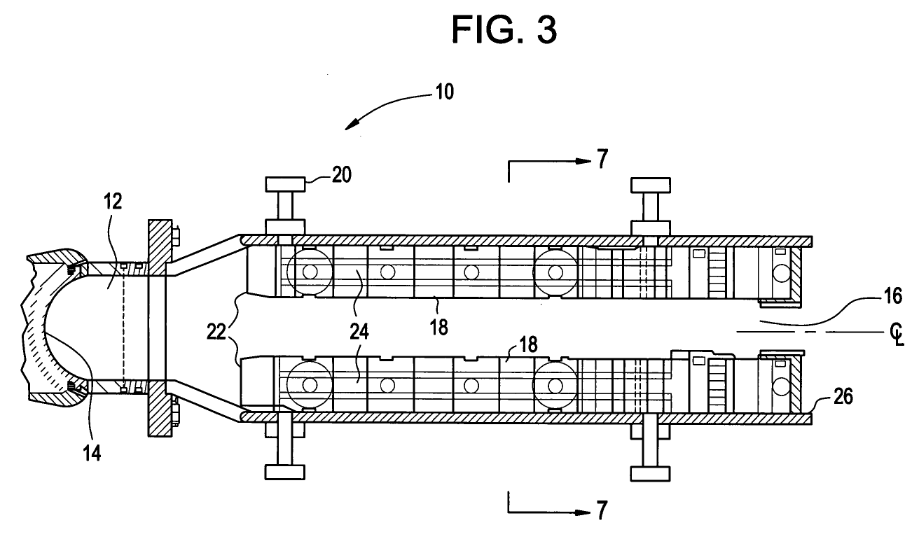

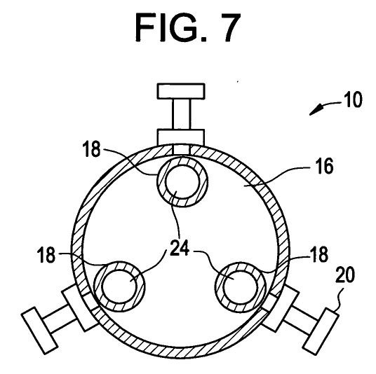

FIG. 3 depicts an alternative to the embodiment shown in FIG. 2, where the detonation initiators 18 are positioned radially with respect to the centerline CL of the device 10. Specifically, the detonation initiators 18 are positioned on an interior exhaust tube surface 26. This is depicted in FIG. 7, which is a cross-section of the device 10 taken along the section III-III. This allows the central portion of the detonation wave from the main combustion chamber 12 to travel along the exhaust tube 16 freely. In an alternative embodiment, the detonation initiators 18 are positioned radially with respect to the device 10 centerline CL, but are positioned inward from the surface 26, such that they are located at a point between the centerline CL and the surface 26. The radial position is optimized for performance of the device 10 and to maximize detonation initiation within the main chamber 12.

However, in the embodiment depicted in FIG. 3, with the detonation initiators 18 positioned along the surface 26, the cooling and supply of the detonation initiators 18 with the fuel mixture is made simpler.

In an additionally embodiment, at least one of the nozzles 22 or detonation initiators 18 are angled with respect to the centerline CL of the device 10 so as to optimize the direction of the detonation wave into the main combustion chamber 12 and with respect to the wave reflection surface 14.

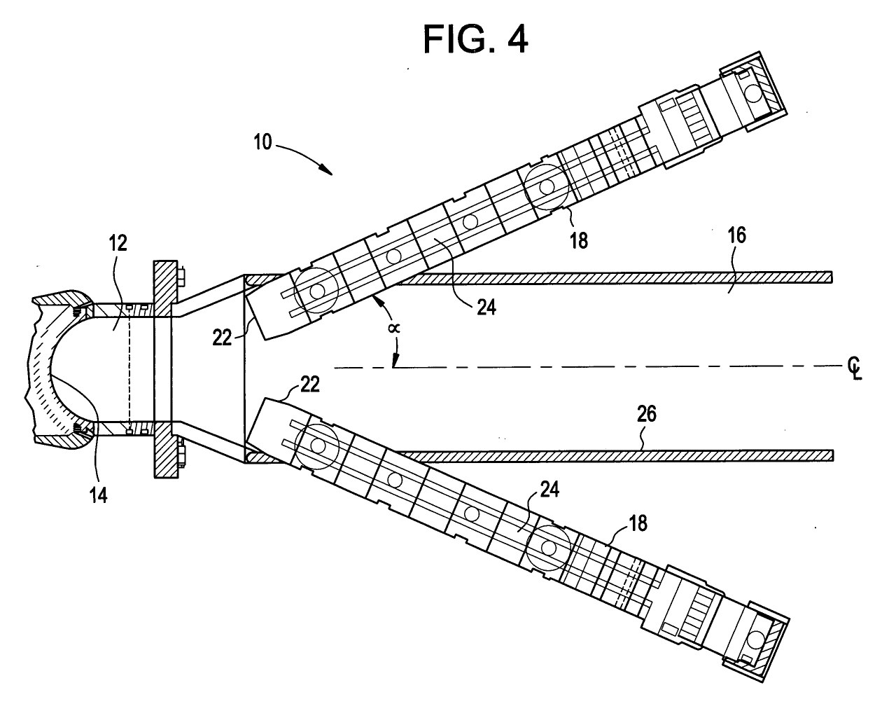

FIG. 4 depicts an additional embodiment of the present invention where at least a portion of the detonation initiators 18 are positioned externally with respect to the exhaust tube 16. This configuration additionally simplifies cooling, supplying and controlling the detonation initiators 18, as at least a portion of the detonation initiators 18 are located external from the high temperature and pressure detonations traveling within the exhaust tube 16. Additionally, the detonation initiators 18 are positioned at an angle a with respect to the centerline of the device 10. The angle α is optimized to ensure proper detonation of the fuel mixture within the main combustion chamber. The angle α is chosen to ensure that the pressure detonation wave passes through the main combustion chamber 12 and the contacts the wave reflection surface 14 at the desired angle.

In an alternative embodiment, the detonation initiators 18 are positioned parallel to the centerline CL of the device 10, but are ducted to the surface 26 of the exhaust tube 16 or main combustion chamber 12. Such a configuration reduces the overall diameter and circumference of the device.

Further, the nozzles 22 extend into the exhaust tube 16 or main combustion chamber 12 to such an extent as to ensure that the detonation initiation wave properly interacts with the fuel mixture in the main combustion chamber 12 to achieve main detonation. In an alternative embodiment, the configuration and structure of the nozzle is optimized to ensure proper detonation initiation wave direction while reducing interference with the main detonation wave exiting the exhaust tube. In one embodiment, the nozzles 22 are controlled by a mechanism which opens the nozzles 22 to the exhaust tube and/or main combustion chamber 12 as the detonation initiation wave escapes the nozzle and then retracts and/or closes the nozzle so as to minimize interference with the propagating detonation wave from the chamber 12. In a further embodiment, the detonation initiators 18 are fired sequentially and only the nozzle 22 of the firing detonation initiator 18 is opened or extended, whereas the remaining non-firing detonation initiators 18 are retracted and/or closed preventing the main detonation wave from entering these non-firing detonation initiators 18.

In a further alternative embodiment, the opening of the nozzles 22 are configured such that they are flush with the surface 26. In this configuration, no portion of the nozzles 22 project beyond the surface 26.

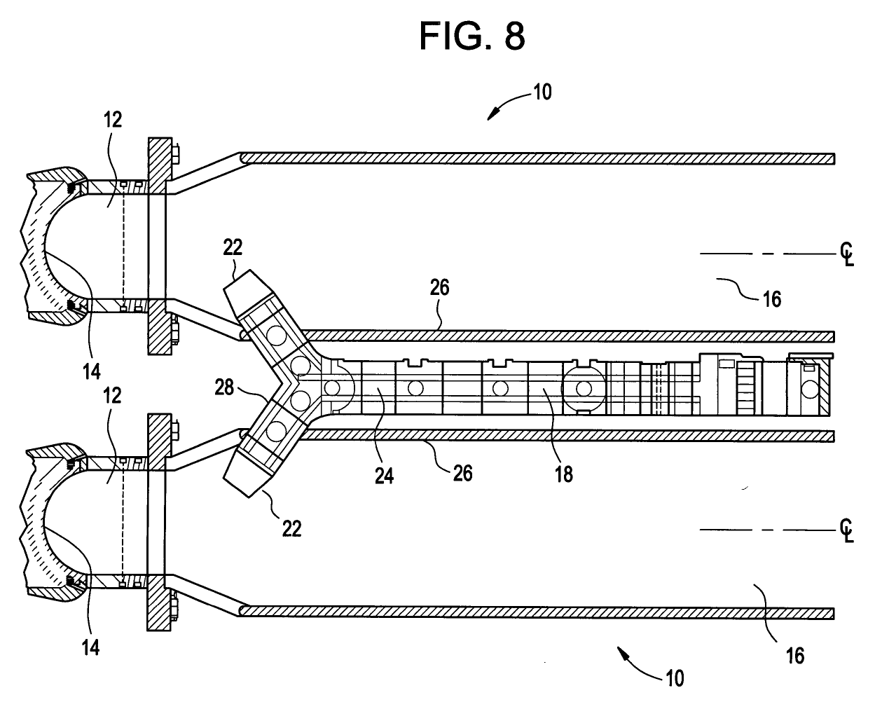

FIG. 8 depicts an additional embodiment of the present invention, where at least one detonation initiator 18 is used to assist in the detonation in at least two main combustion chambers 12. The detonation initiator 18 is ducted such that it has a nozzle 22 in each of the two combustion devices 10. The flow of the detonation initiation wave is controlled by a valve mechanism (not shown) within the duct structure 28 which directs the detonation initiation wave through the respective nozzle 22 into the device 10 in which the detonation is to occur.

This configuration allows for longer fill times of the fuel air mixture within the respective combustion chambers 12, as well as allowing for optimized cooling of the respective combustion devices 10. In a further embodiment, at least one detonation initiator 18 assists the detonation in more than two combustion devices 10. Whereas in a further embodiment, more than one detonation initiators 18 are used to alternatively control more than one combustion devices 10. For example, in an engine containing four combustion devices 10, two detonation initiators 18 are used to alternatively assist detonation in two of the four devices 10.

In a further embodiment, the ducting 28 and valve are configured such that portions of the detonation wave from the initiator 18 are directed to the respective main combustion chambers 12 simultaneously, so as to initiate, or assist in the initiation, of the fuel mixture within the respective chambers 12.

While the invention has been described in terms of various specific embodiments, those skilled in the art will recognize that the invention can be practiced with modification within the spirit and scope of the claims. Namely, although the present invention has been discussed in the context of aircraft engine applications, it is contemplated that the present invention can be employed in all applications which use gas turbine engines, constant volume combustion engines, or the like.

1. A combustion device comprising:
a main combustion chamber coupled to a wave reflection surface on a forward side of said main combustion chamber; and
at least one detonation initiator positioned proximate to at least one of said wave reflection surface and said main combustion chamber;
wherein said at least one detonation initiator is positioned such that at least a portion of a detonation wave emitted from said at least one detonation initiator is directed toward at least one of said wave reflection surface and said main combustion chamber.

2. The combustion device of claim 1, wherein said at least one detonation initiator is positioned centrally within said combustion device.

3. The combustion device of claim 1, wherein said at least one detonation initiator is positioned radially with respect to a centerline of said combustion device.

4. The combustion device of claim 1, wherein at least a portion of said at least one detonation initiator is positioned within an exhaust tube of said combustion device and said at least one detonation initiator is mounted on a surface of said exhaust tube.

5. The combustion device of claim 1, wherein said at least one detonation initiator is a deflagration to detonation tube.

6. The combustion device of claim 1, wherein said combustion device is a pulse detonation combustion device.

7. The combustion device of claim 1, wherein said at least one detonation initiator assists in the detonation of a fuel and gas mixture within said main combustion chamber.

8. The combustion device of claim 7, wherein said gas is air.

9. The combustion device of claim 7, wherein said at least one detonation initiator uses the same fuel and gas mixture as used within said main combustion chamber.

10. The combustion device of claim 1, wherein said at least one detonation initiator comprises a nozzle at an exit of said at least one detonation initiator.

11. The combustion device of claim 10, wherein said nozzle is a converging-diverging nozzle.

12. The combustion device of claim 10, wherein said nozzle is a converging nozzle.

13. The combustion device of claim 12, wherein said at least one detonation initiator further comprises an exhaust tube and a diameter of an exit opening of said nozzle is 80% of a diameter of said initiator exhaust tube.

14. The combustion device of claim 1, wherein said combustion device further comprises an exhaust tube having a surface, and said at least one detonation initiator is located external to said exhaust tube.

15. The combustion device of claim 1, wherein said detonation wave is emitted from said at least one detonation initiator at an angle with respect to a centerline of said combustion device.

16. The combustion device of claim 1, wherein a shape of said wave reflection device is configured to focus at least a portion of said detonation wave into said main combustion chamber.

17. The combustion device of claim 1, wherein said at least one detonation initiator is configured to allow at least a portion of a detonation wave from said main combustion chamber to enter said at least one detonation initiator to assist in generating said detonation initiator detonation wave.

18. The combustion device of claim 1, wherein said at least one detonation initiator is positioned rearward of at least one of said wave reflection surface and said main combustion chamber.

19. A combustion device comprising:
a main combustion chamber coupled to a wave reflection surface on a forward side of said main combustion chamber; and
a plurality of detonation initiators positioned proximate to at least one of said main combustion chamber and said wave reflection surface;
wherein at least one of said detonation initiators is positioned such that at least a portion of a detonation wave emitted from said at least one detonation initiator is directed toward at least one of said main combustion chamber and said wave reflection surface.

20. The combustion device of claim 19, wherein said plurality of detonation initiators are positioned centrally within said combustion device.

21. The combustion device of claim 19, wherein said plurality of detonation initiators are positioned radially with respect to a centerline of said combustion device.

22. The combustion device of claim 19, wherein at least a portion of said plurality of detonation initiators are positioned within an exhaust tube of said combustion device and said plurality of detonation initiators are mounted on a surface of said exhaust tube.

23. The combustion device of claim 19, wherein said plurality of detonation initiators are positioned symmetrically.

24. The combustion device of claim 19, wherein at least one of said detonation initiators is a deflagration to detonation tube.

25. The combustion device of claim 19, wherein said combustion device is a pulse detonation combustion device.

26. The combustion device of claim 19, wherein said detonation initiators assist in the detonation of a fuel and gas mixture within said main combustion chamber.

27. The combustion device of claim 26, wherein said gas is air.

28. The combustion device of claim 26, wherein at least one of said detonation initiators uses the same fuel and gas mixture used within said main combustion chamber.

29. The combustion device of claim 19, wherein at least one of said detonation initiators comprises a nozzle at an exit of said at least one detonation initiator.

30. The combustion device of claim 29, wherein said nozzle is a converging-diverging nozzle.

31. The combustion device of claim 29, wherein said nozzle is a converging nozzle.

32. The combustion device of claim 31, wherein said at least one detonation initiator further comprises an exhaust tube and a diameter of an exit opening of said nozzle is 80% of a diameter of said initiator exhaust tube.

33. The combustion device of claim 19, wherein said combustion device further comprises an exhaust tube having a surface, and said detonation initiators are located external to said exhaust tube.

34. The combustion device of claim 19, wherein said detonation wave is emitted from said at least one detonation initiator at an angle with respect to a centerline of said combustion device.

35. The combustion device of claim 19, wherein a shape of said wave reflection device is configured to focus at least a portion of said detonation wave into said main combustion chamber.

36. The combustion device of claim 19, wherein said at least one detonation initiator is configured to allow at least a portion of a detonation wave from said main combustion chamber to enter said at least one detonation initiator to assist in generating said detonation initiator detonation wave.

37. The combustion device of claim 19, wherein said at least one detonation initiator is positioned rearward of at least one of said wave reflection surface and said main combustion chamber.

38. The combustion device of claim 19, wherein each of said detonation initiators emits a detonation wave simultaneously at at least one of said main combustion chamber and said wave reflection surface.

39. The combustion device of claim 19, wherein each of said detonation initiators emits a detonation wave sequentially, and wherein at least one of said detonation initiators not emitting a detonation wave injects a fuel and gas mixture into said main combustion chamber.

40. A combustion device comprising:
at least two main combustion chambers, each coupled to an respective wave reflection surface on a forward side of each of said main combustion chambers; and
at least one detonation initiator positioned proximate to at least one of said wave reflection surfaces and said main combustion chambers;
wherein said at least one detonation initiator is positioned such that at least a portion of a detonation wave emitted from said at least one detonation initiator is directed toward at least one of said wave reflection surfaces and toward at least one of said main combustion chambers.

41. The combustion device of claim 40, wherein said at least one detonation initiator directs said portion of said detonation wave at each of said wave reflection surfaces or at each of said main combustion chambers in an alternating sequence.

42. The combustion device of claim 40, wherein a duct manifold directs said portion of said detonation wave toward said main combustion chamber or said wave reflection surface.

43. A combustion device comprising:
a main combustion chamber coupled to a wave reflection surface on a forward side of said main combustion chamber and an exhaust tube on a downstream side of said main combustion chamber; and
at least one detonation initiator having a nozzle and an exhaust tube, said at least one detonation initiator proximate to and downstream of both of said wave reflection surface and said main combustion chamber,
wherein said at least one detonation initiator is positioned such that a detonation wave emitted from said at least one detonation initiator is directed in a direction at both of said wave reflection surface and said main combustion chamber, and
wherein said nozzle is a converging nozzle having an exit diameter 80% of a diameter of said detonation initiator exhaust tube.

44. A combustion device comprising:
a main combustion chamber coupled to a wave reflection surface on a forward side of said main combustion chamber and an exhaust tube on a downstream side of said main combustion chamber; and
at plurality of detonation initiators positioned symmetrically with respect to a centerline of said combustion device, each having a nozzle and an exhaust tube, said plurality of detonation initiators positioned proximate to and downstream of both said wave reflection surface and said main combustion chamber,
wherein said detonation initiators are positioned such that a detonation wave emitted from each of said detonation initiators is directed at both of said wave reflection surface and said main combustion chamber, and
wherein said detonation initiators each emit said detonation wave sequentially with respect to each other.
